(19) United States
(12) Patent Application Publication
(10) Pub. No.: US 2026/0349387 A1
(43) Pub. Date: Nov. 5, 2026

(54) DRIVE DEVICE FOR A TIMEPIECE MECHANISM

(71) Applicant: RICHEMONT INTERNATIONAL SA, Villars-sur-Glâne (CH)

(72) Inventor: Martin CRETEGNY, Genève (CH)

(21) Appl. No.: 19/112,520

(22) PCT Filed: Jul. 28, 2023
(86) PCT No.: PCT/IB2023/057697

§ 371 Date: Mar. 17, 2025

(30) Foreign Application Priority Data
Nov. 4, 2022 (CH) CH001313/2022

(51) Int. Cl. G04B 13/02

(52) U.S. Cl. CPC G04B 13/02

(57) ABSTRACT

Drive device (1) for a timepiece mechanism, comprising a drive member (2) mounted so as to be rotationally movable around a rotary shaft (10) and configured to drive a timepiece mechanism, the drive member (2) comprising a plurality of bearing surfaces (21), a first transmission member (3) movable from a first position of the first transmission member (3) to a second position of the first transmission member (3) and from the second position of the first transmission member (3) to the first position of the first transmission member (3), a second transmission member (4) movable from a first position of the second transmission member (4) to a second position of the second transmission member (4) and from the second position of the second transmission member (4) to the first position of the second transmission member (4), each transmission member (3; 4) being configured in order, during its movement from its second position to its first position, to drive the drive member (2) to rotate by cooperating with a bearing surface (21) of the plurality of bearing surfaces (21), the second transmission member (4) being configured not to block the rotation of the drive device (2) when the first transmission member (3) drives the drive member (2) and the first transmission member (3) being configured not to block the rotation of the drive member (2) when the second transmission member (4) drives the drive member (2). Timepiece comprising a timepiece movement and such a drive device, wherein the first transmission member is moved from its first position to its second position by the timepiece movement and the second transmission member is configured to be moved from its first position to its second position by a manual control mechanism.

The present invention relates to a drive device for a timepiece mechanism. The present invention relates in particular to a drive device allowing activation of a timepiece mechanism, for example an animation, display and/or striking mechanism, upon passage or upon request.

Some timepieces comprise one or more complications allowing the displaying of additional information in addition to the time, for example other time-related information, and/or the creation of a decorative and entertaining animation, and/or the emission of a sound for example to indicate the time or for an alarm. These complications comprise timepiece mechanisms which, when they are integrated into a timepiece, are arranged to be activated upon passage, i.e. at specific moments such as for example upon passage of the hour, or upon request via a control member which can be actuated by the user. Typically, the animation or display moves cyclically: starting from an initial position, the one or more animation or display members move in a specific sequence of positions before returning to their initial position. Similarly, the striking movements generally emit a predetermined striking cycle upon each activation, corresponding for example to time information.

The timepiece mechanism of such a complication is generally associated with a transmission member which transmits to the timepiece mechanism the power required to make the animation, display and/or striking member or members move. In the case where the timepiece mechanism is associated with a timepiece movement of a timepiece, the transmission member can be for example supplied with power by the drive member of the timepiece movement or can be independent of the timepiece movement.

The possibility of activating a complication upon passage and upon request generally requires a drive device of the timepiece mechanism which is relatively complex, sometimes requiring two separate drive members. The size and complexity of such devices can make the integration thereof into a timepiece, in particular a wristwatch, complicated.

An aim of the present invention is to propose a drive device for a timepiece mechanism which allows the activation of a timepiece mechanism upon passage and upon request with a single drive member.

Another aim of the present invention is to propose a drive device for a timepiece mechanism which allows the activation of a timepiece mechanism upon passage and upon request in a simple and compact manner with a minimum number of moving parts.

These aims and other advantages are achieved by a drive device for a timepiece mechanism, comprising a drive member mounted so as to be rotationally movable around a rotary shaft and configured to drive a timepiece mechanism, the drive member comprising a plurality of bearing surfaces; a first transmission member movable in a winding movement from a first position of the first transmission member to a second position of the first transmission member and in a return movement from its second position to its first position; a second transmission member movable in a winding movement from a first position of the second transmission member to a second position of the second transmission member and in a return movement from its second position to its first position; each transmission member being configured in order, during its return movement from its second position to its first position, to drive the drive member to rotate by cooperating with a bearing surface of the plurality of bearing surfaces; the second transmission member being configured not to block the rotation of the drive device when the first transmission member drives the drive member, and the first transmission member being configured not to block the rotation of the drive member when the second transmission member drives the drive member.

A timepiece mechanism can thus be driven by a single drive member which can be caused to move either by a first transmission member or by a second transmission member, without the movement of the drive member being prevented by the inactive transmission member.

The first transmission member and the second transmission member are preferably mounted so as to be rotationally movable about the rotary shaft and rotate in one direction of rotation during the winding movement and in the opposite direction of rotation during the return movement.

In accordance with a preferred embodiment, the first transmission member and the second transmission member each comprise a pushing member for cooperating with the bearing surfaces to urge the drive member to rotate, each pushing member being located at the distal end of a flexible arm, the proximal end of each of said flexible arms being rotatably mounted about the rotary shaft.

The first and second transmission members can thus each urge the drive member to rotate by having their pushing member press against a bearing surface of the drive member, the inactive transmission member allowing the rotation of the drive member in the manner of a pawl.

In accordance with some embodiments, the drive device further comprises a first spring to move the first transmission member in its winding movement from its second position to its first position, and a second spring to move the second transmission member in its winding movement from its second position to its first position. The first and second springs are preferably configured to be wound during the winding movement of the respective transmission member from its first position to its second position, a winding movement which is effected against the return force of the spring.

The drive member comprises teeth for example.

The bearing surfaces are preferably regularly distributed around the rotary shaft on a diameter of the drive member. This allows step-by-step advancement of the drive member upon each activation by a transmission member, the angular pitch of the drive member corresponding for example to the angle between two adjacent bearing surfaces, or to a multiple thereof.

The bearing surfaces are preferably formed on an inner periphery of a ring of the drive member, the ring preferably being located protruding from the plate of the drive member. This represents the advantage that the transmission members can be at least partially disposed within this ring, thereby allowing a compact design for the drive device in accordance with the invention.

Optionally, the drive device comprises a deactivation mechanism allowing, for example, the first transmission member to be decoupled from the drive member. This allows, in particular when the first transmission member is controlled upon passage by a timepiece movement, the deactivation of the first transmission member when setting the timepiece movement to time so as to avoid damaging the drive device. This also allows, alternatively or in addition, and with suitable control, the temporary deactivation of the timepiece mechanism driven by the drive device.

The above-mentioned aims and other advantages are also achieved by a timepiece comprising a timepiece movement and such a drive device, wherein the first transmission member is moved in its winding movement from its first position to its second position by the timepiece movement, and the second transmission member is configured to be moved in its winding movement from its first position to its second position by a manual control mechanism.

In such a timepiece, the deactivation mechanism is preferably actuated automatically when the timepiece movement is able to receive a time-setting operation, for example when the winding stem is pulled.

Alternatively or in addition, the deactivation mechanism can be actuated upon request by a user, e.g. using an “on/off” button which can be accessed by a user of the timepiece.

The timepiece is for example a wrist-watch.

The present invention will be better understood with the aid of the description below which is illustrated in the figures, where:

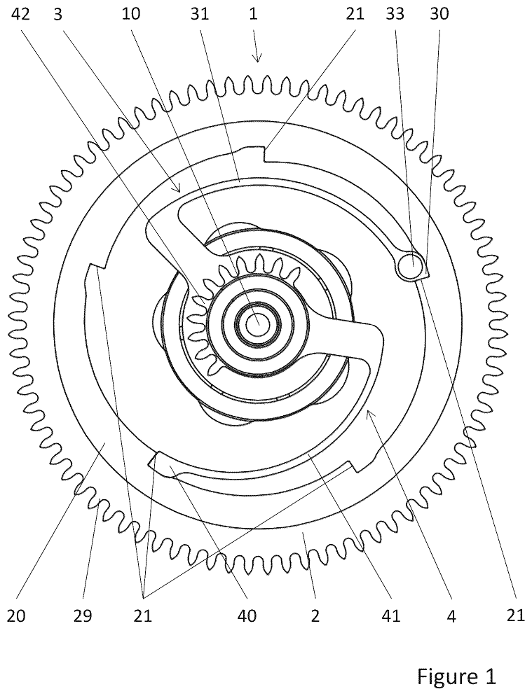

FIG. 1 partially illustrates a drive device in accordance with an embodiment of the invention;

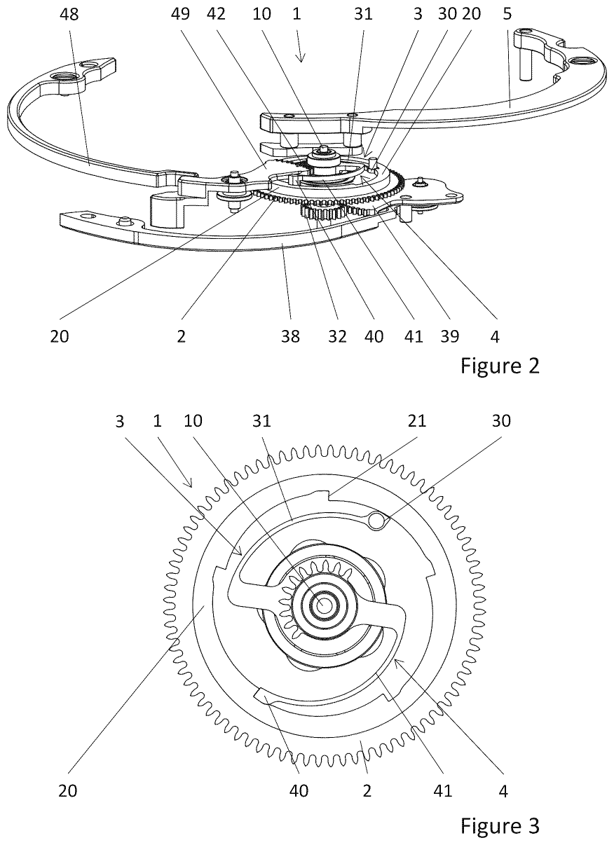

FIG. 2 is a perspective view of the drive device partially illustrated in FIG. 1;

FIGS. 3 to 7 illustrate the activation of the drive device of FIG. 1 by a first transmission member;

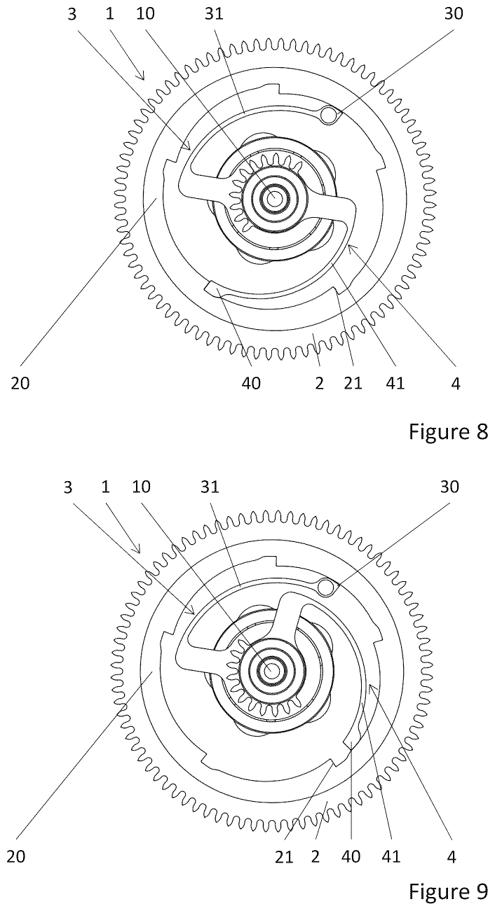

FIGS. 8 to 11 illustrate the activation of the drive device of FIG. 1 by a second transmission member;

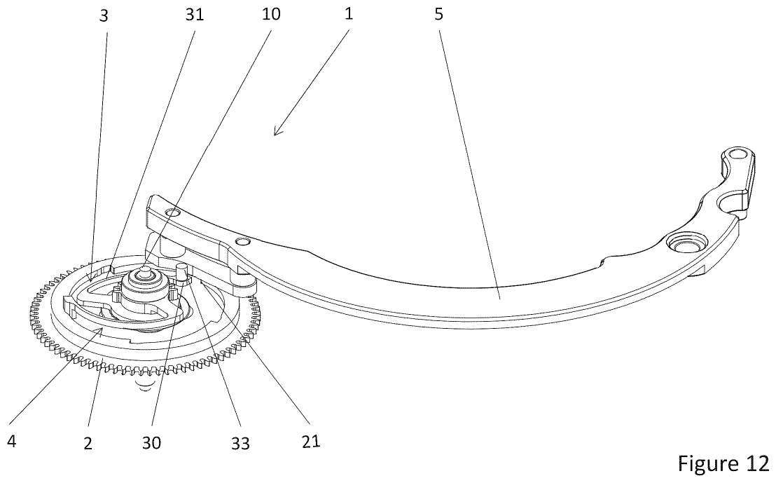

FIG. 12 shows, in detail, a deactivation mechanism for the drive device of FIG. 1.

The drive device 1 of the invention is a device allowing activation, for example upon passage or upon request, of a timepiece mechanism, not shown, for example an animation, display and/or striking mechanism. Preferably, the drive device 1 is intended to drive a timepiece mechanism operating cyclically, for example by animation, display or striking cycles, and the drive device 1 is configured to advance step-by-step, each step preferably corresponding to a cycle of the driven timepiece mechanism.

With reference to the figures, the drive device 1 of the invention comprises a drive member 2 mounted so as to be rotationally movable about a rotary shaft 10. The drive member 2 is configured to drive the timepiece mechanism driven by the drive device 1. In accordance with the illustrated embodiment, the drive member 2 is for example a toothed wheel, the teeth 29 are intended to mesh with a mating mobile, not shown, for example a toothed wheel, of the timepiece mechanism. However, other configurations of the drive member are possible within the scope of the invention. In accordance with some embodiments, the drive member is for example a cam or teeth actuating hammer lifting pieces for a striking mechanism.

According to the invention, the drive device 1 comprises two transmission members 3, 4 for causing the drive member 2 to move about the rotary shaft 10 so as to actuate the timepiece mechanism driven by drive device 1. According to the invention, each transmission member 3, 4 is configured to cause only the drive member 2 to move. Each transmission member 3, 4 is also configured to allow the movement of the drive member 2 when this is caused to move by the other transmission member 4, 3. Each time the drive member 2 is caused to move by a transmission member 3, 4, it is preferably advanced by one predetermined step in one direction of rotation, for example in the clockwise direction. The step is preferably determined to correspond to the driving of the timepiece mechanism over a complete cycle.

As explained in more detail below, each transmission member 3, 4 is configured to effect a reciprocating movement between a first position, for example an inactive position, and a second position, for example a winding position. During the movement of the transmission member 3, 4 from its inactive position to its winding position, the drive member 2 is not caused to move by the transmission member 3, 4. During the return of the transmission member 3, 4 in the opposite direction from its winding position to its inactive position, the drive member is caused to move and is rotated by one step around the rotary shaft 10 in a specific direction, for example in the clockwise direction.

In accordance with the illustrated embodiment, each transmission member 3, 4 comprises a pushing member 30, 40 configured to come into contact with a bearing surface 21 of the drive member 2 so as to urge the drive member 2 to rotate over at least one fraction of a turn, corresponding for example to a full cycle of the timepiece mechanism driven by the drive device 1. Each pushing member 30, 40 is for example located at the distal end of a flexible arm 31, 41, the proximal end of which is mounted so as to rotate, for example about the rotary shaft 10, about which the drive member 2 is also mounted so as to rotate. Each flexible arm 31, 41 is preferably configured so as to be flexible in a radial direction with respect to the rotary shaft 10 so as to be able to slide on a surface of the drive member 2 when the latter is caused to move by the other flexible arm 41, 31, and rigid in a tangential direction with respect to the rotary shaft 10 so as to be able to urge the drive member 2 to rotate by cooperation of the corresponding pushing member 30, 40 and a bearing surface 21. Each transmission member 3, 4 thus acts as a pawl, allowing the rotation of the drive member 2 relative to the transmission member 3, 4 in a first direction of rotation and blocking the rotation of the drive member 2 relative to the transmission member 3, 4 in a second direction of rotation opposite to the first, as soon as the corresponding pushing member 30, 40 comes into contact with a bearing surface 21 of the drive member 2. Each flexible arm 31, 41 comprises, for example, a rigid base rotatably mounted on the rotary shaft 10 and extending essentially radially from the rotary shaft 10, and an elongate part extending from the end of the rigid base essentially as an arc of a circle with respect to the rotary shaft 10 and flexible in a radial direction with respect to the rotary shaft 10.

In accordance with this embodiment, the drive member 2 preferably comprises a plurality of bearing surfaces 21 intended to cooperate with the pushing members 30, 40 for causing rotation of the drive member 2. The bearing surfaces 21 are for example formed by inner notches formed on a ring 20 of the drive member 2. The ring 20 is for example located protruding on the plate of the toothed wheel 2. The ring 20 is for example formed in one piece with the drive member 2 or is fixed, for example welded, to the drive member 2. The notches are preferably uniformly distributed on the inner circumference of the ring 20. In the illustrated case, there are five notches, each separated by 72°.

Preferably, the transmission members 3, 4 are configured to be actuated independently of each other. A first transmission member 3 of the two transmission members 3, 4 is for example intended to be actuated by a timepiece movement, for example by the timepiece movement of a timepiece in which the drive device 1 and the timepiece mechanism driven by the drive device 1 are integrated. A second transmission member 4 of the two transmission members 3, 4 is for example intended to be actuated by a control mechanism which can be actuated upon request by a user of the timepiece using, for example, a button or any other suitable actuator located on the case of the timepiece.

With reference to FIG. 2, the first transmission member 3 comprises for example a pinion 32 fixed to the flexible arm 31 of the first transmission member 3 for conjoint rotation with said arm. The pinion 32 meshes for example with a first rack 39 intended to be driven by a timepiece movement. When the drive device 1 is integrated into a timepiece, the running of the timepiece movement of the timepiece drives for example the first rack 39 in a winding movement to rotate in the clockwise direction against the force of a first spring 38, for example a first leaf spring. The rotation in the clockwise direction of the first rack 39 drives the first transmission member 3 to rotate in the anti-clockwise direction. The first spring 38 exerts on the first rack 39 an elastic force tending to return it, in the anti-clockwise direction, to a first position of the first rack 39, typically an inactive position, which corresponds to a first position of the first transmission member 3. At a moment determined by the timepiece movement, the first rack 39 which has reached a second position corresponding to a second position of the first transmission member 3, typically a winding position, is released by the timepiece movement and returns, in the anti-clockwise direction, to its inactive position under the effect of the first spring 38. In so doing, it drives the first transmission member 3 in the clockwise direction over at least a fraction of a turn. As explained in more detail below, during this return movement of the first rack 39, the pushing member 30 of the first transmission member 3 comes to bear against a bearing surface 21 of the drive member 2 and urges it to rotate over a fraction of a turn preferably corresponding to a cycle, for example an animation, display and/or striking cycle, of the timepiece mechanism driven by the drive device 1.

The second transmission member 4 comprises for example a rack 42 fixed to the flexible arm 41 of the second transmission member 4 for conjoint rotation with said arm. The rack 42 meshes for example with a second rack 49 intended to be driven by a control mechanism upon request. When a user of the timepiece in which the drive device is integrated actuates the control mechanism, e.g. by pressing on a button of the timepiece, the second rack 49 is driven in a winding movement to rotate in the clockwise direction against the force of a second spring 48, for example a second leaf spring. The rotation in the clockwise direction of the first rack 39 drives the first transmission member 3 to rotate in the anti-clockwise direction. The first spring 38 exerts on the second rack 49 an elastic force tending to return it, in the anti-clockwise direction, to a first position of the second rack 49, typically an inactive position, which corresponds to a first position of the second transmission member 4. For example, when the user releases the button and/or when the button has travelled a predetermined distance, the second rack 49 which has reached a second position corresponding to a second position of the second transmission member 4, typically a winding position, is released by the manual control mechanism and returns to its inactive position in the anti-clockwise direction under the effect of the second spring 48. In so doing, it drives the second transmission member 4 in the clockwise direction over at least a fraction of a turn. As explained in more detail below, during this return movement of the second rack 49, the pushing member 40 of the second transmission member 4 comes to bear against a bearing surface 21 of the drive member 2 and urges it to rotate over a fraction of a turn preferably corresponding to a cycle, for example an animation, display and/or striking cycle, of the timepiece mechanism driven by the drive device 1.

In accordance with the illustrated embodiment, upon each return movement of the first rack 39 or of the second rack 49, the drive member 2 is driven to rotate by the corresponding transmission member 3, 4 over a specific fraction of a turn, for example a fifth of a turn, i.e. 72 degrees. This fraction of a turn corresponds to one step of the drive member 2 which preferably corresponds to the angular pitch between two adjacent bearing surfaces 21 of the drive member 2, or to a multiple thereof.

FIGS. 3 to 7 illustrate the winding movement of the first transmission member 3 and the rotation of the drive member 2 during the return movement of the first transmission member 3.

With respect to a first position, typically an inactive position, of the first and second transmission members 3, 4 illustrated in FIG. 1, FIG. 3 shows the first transmission member 3 partially wound, typically between two activations upon passage of the timepiece mechanism driven by the drive device 1. During the winding movement of the first transmission member 3, the second transmission member 4 and the drive member 2 are immobile whilst the control mechanism of the second transmission member 4 is not activated by a user. As explained previously, the first transmission member 3 is driven in the anti-clockwise direction preferably by the timepiece movement of the timepiece in which the drive device 1 is integrated. The rotational speed of the first transmission member 3 during the winding movement is determined by a suitable configuration of the kinematic chain linking the first transmission member 3 to the timepiece movement, as a function for example of the periodicity with which the timepiece mechanism must be activated, for example every 15 minutes, once an hour, once or twice a day, etc. During the winding movement, the pushing member 30 of the first transmission member 3 slides along the inner periphery of the ring 20 with a frictional force determined by the flexibility of its flexible arm 31.

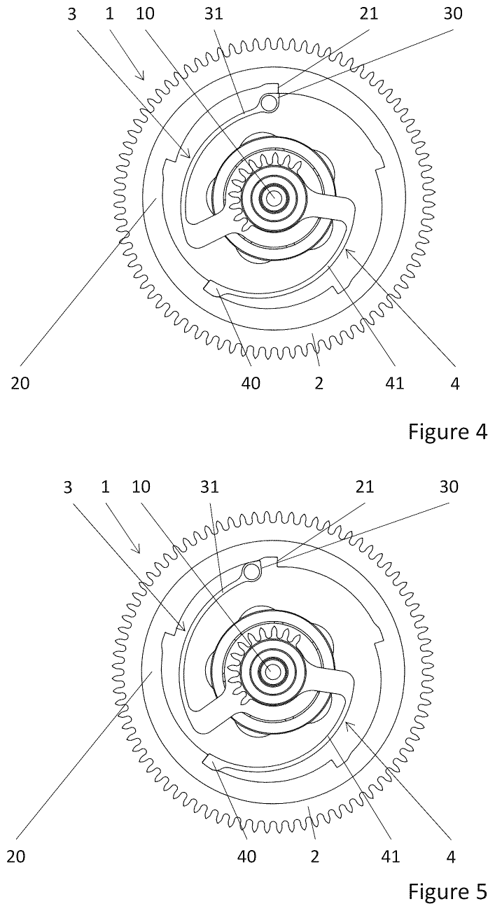

FIG. 4 shows the first transmission member 3 during winding just before its pushing member 30 falls into the next notch of the ring 20 under the effect of the elastic force of its flexible arm 31. FIG. 5 shows a second position of the first transmission member 3 at the end of the winding movement, typically a winding position. Preferably, the angular displacement of the first transmission member 3 during the winding movement is greater than the angular pitch between two notches of the drive member 2 so as to ensure that the pushing member 30 is passed over the next notch at the end of the winding movement, as illustrated in FIG. 4. In the illustrated embodiment, for example, since there are five notches the angular pitch between them is 72°. The first transmission member 3 is thus rotated by an angle greater than 72° during the winding movement, preferably by an angle greater than 80°, for example an angle of 90°.

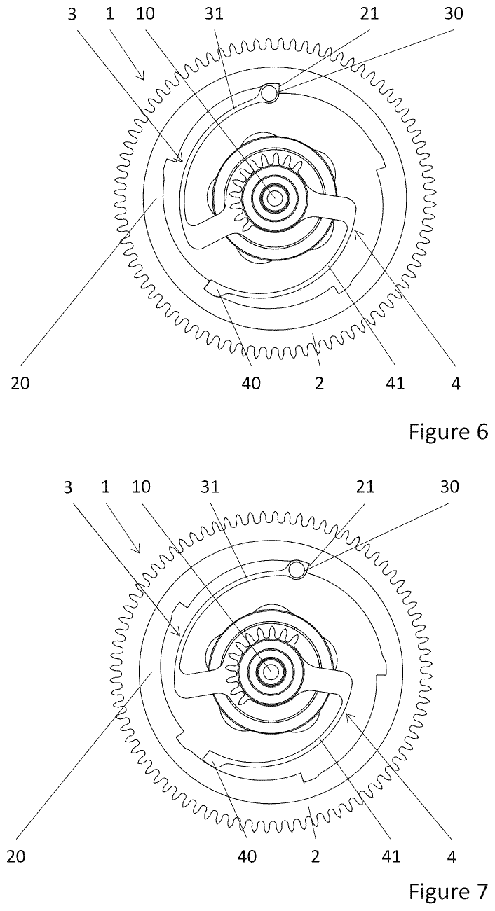

At a time determined by the timepiece movement, the wound first transmission member 3 is released and tends to return in the clockwise direction from the second position, typically the winding position, to the first position, typically the inactive position illustrated in FIG. 1 under the effect of the first spring 38. During the return movement of the first transmission member 3, the pushing member 30 of the first transmission member 3 is inserted into the next notch of the ring 20, as illustrated in FIG. 6, and pushes against the corresponding bearing surface 21 to cause the drive member 2 to move in the clockwise direction, as illustrated in FIG. 7. During this rotational movement of the drive member 2 under the effect of the first transmission member 3, the pushing member 40 of the second transmission member 4 slides on the inner circumference of the ring 20 with a force determined by the flexibility of the flexible arm 41 of the second transmission member 4, as well as by the type and surface condition of the materials used to manufacture the flexible arm 41 and the ring 20, without preventing this rotation. At the end of the return movement of the first transmission member 3, the drive member 2 has been rotated by an angle corresponding to the angular pitch between two bearing surfaces 21, for example a fifth of a turn, and the first drive member 3 is again in the inactive position which it occupied in FIG. 1.

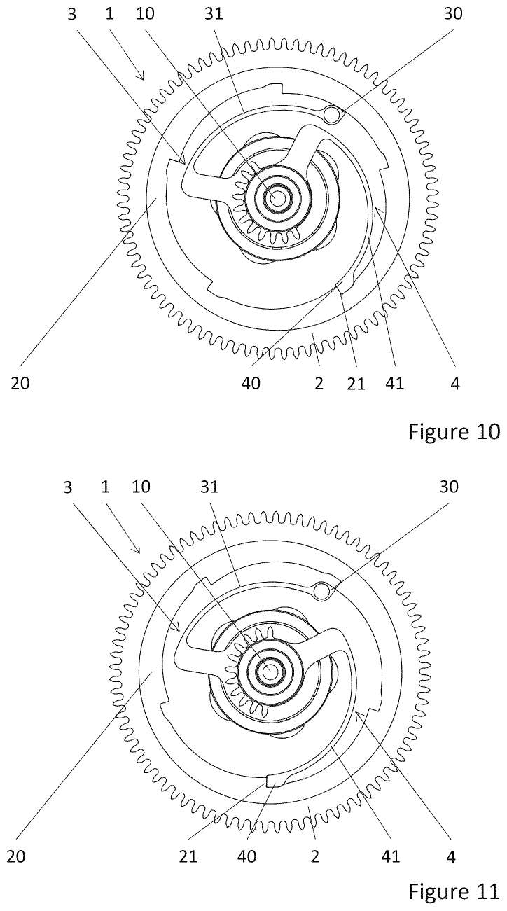

FIGS. 8 to 11 illustrate the activation of the drive member 2 by the second transmission member 4, for example activation upon request between two activations upon passage by the first transmission member 3. FIG. 8 shows an example of a starting position in which the first transmission member 3 is partially wound and the second transmission member 4 is in a first position, typically its inactive position. In a first time, the second transmission member 4 is wound, for example via a manual control mechanism actuated using a button on the time piece which a user can access. During the winding movement, the second transmission member 4 is driven in the anti-clockwise direction and the pushing member 40 of the second transmission member 4 slides against the inner periphery of the ring 20 until it passes over the next notch. The angular displacement of the second transmission member 4 during the winding movement is preferably greater than the angular pitch between two notches of the drive member 2 so as to ensure that the pushing member 40 is passed over the next notch at the end of the winding movement, as illustrated in FIG. 9. In the illustrated embodiment, for example, the second transmission member 4 is rotated by an angle greater than 72° during the winding movement, preferably by an angle greater than 80°, for example an angle of 90°. Once wound, in a second position illustrated in FIG. 9, typically a winding position, the second transmission member 4 is released and tends to return in the clockwise direction from its second position, typically its winding position, to its first position, typically its inactive position, under the effect of the second spring 48. During the return movement of the second transmission member 4, the pushing member 40 of the second transmission member 4 is inserted into the next notch of the ring 20, as illustrated in FIG. 10, and pushes against the corresponding bearing surface 21 to cause the drive member 2 to move in the clockwise direction, as illustrated in FIG. 11. During this rotational movement of the drive member 2 under the effect of the second transmission member 4, the pushing member 30 of the first transmission member 3 slides on the inner circumference of the ring 20 with a force determined by the flexibility of the flexible arm 31 of the first transmission member 3, as well as by the type and surface condition of the materials used to manufacture the flexible arm 31 and the ring 20, without preventing this rotation. At the end of the return movement of the second transmission member 4, the drive member 2 has been rotated by an angle corresponding to the angular pitch between two bearing surfaces 21, for example a fifth of a turn, and the second drive member 4 is again in the inactive position which it occupied for example in FIG. 8.

As illustrated in FIG. 2, the flexible arm 31 of the first transmission member 3 is preferably located in another plane than the flexible arm 41 of the second transmission member 4, thereby allowing the movement of each transmission member 3, 4 independently of each other, without a risk of collision.

Preferably, and with reference to FIG. 12, the drive device 1 of the invention further comprises a deactivation mechanism making it possible to deactivate the first transmission member 3 so as to allow, for example, the time-setting of the timepiece in which the drive device 1 is integrated without a risk of damaging the drive device or triggering by the first transmission member 3. The deactivation mechanism is, for example, actuated automatically during the time-setting of the timepiece, for example via the crown stem, not shown. Alternatively or in addition, the deactivation mechanism can be actuated upon request, for example to allow the user of the timepiece to temporarily deactivate the activation upon passage of the timepiece mechanism driven by the drive device 1 of the invention. This allows for example a user to deactivate the corresponding animation, display and/or striking of the timepiece for a certain time. Actuation upon request of the deactivation mechanism 5 is achieved for example using a button, for example an “on/off” button of the timepiece which the user can access.

In accordance with the illustrated embodiment, the deactivation mechanism comprises a deactivation arm 5 acting on the flexible arm 31 of the first transmission member 3, against the return force thereof, to move the pushing member 30 of the first transmission member 3 away from the ring 20 such that it no longer comes into contact with the bearing surfaces 21. The deactivation arm 5 acts on the flexible arm 31 of the first transmission member 3 for example via a pin 33 located preferably in proximity to the distal end of the flexible arm 31, for example on the corresponding pushing member 30.

In accordance with the illustrated embodiment, the drive member 2 comprises five bearing surfaces 21 regularly distributed around the rotary shaft 10 on a diameter of the drive member 2. However, other embodiments are possible within the scope of the invention. In particular, the number of bearing surfaces may be different, determined for example by the angular pitch that the drive member must cover to drive the timepiece mechanism during a full cycle upon each activation. The distribution of the bearing surfaces around the rotary shaft can also be irregular if, for example, the timepiece mechanism driven by the drive device is configured to effect a sequence of cycles, some cycles in the sequence of cycles having a different duration.

It is also feasible to configure the drive device of the invention so that upon each activation of the drive member by the first transmission member and/or by the second transmission member, the drive member is rotated by one step which is a multiple of the angular pitch between two adjacent bearing surfaces.

In accordance with the illustrated embodiment, the transmission members are configured to cause the drive member to rotate in the clockwise direction upon each step, each actuating member 3, 4 being configured to rotate in the anti-clockwise direction during the winding movement and in the clockwise direction during the return movement. It is of course feasible within the scope of the invention to configure the transmission members to cause the drive member to rotate in the anti-clockwise direction upon each step, each actuating member 3, 4 thus being configured to rotate in the clockwise direction during the winding movement and in the anti-clockwise direction during the return movement, the orientation of the bearing surfaces of the drive member thus being inverted with respect to the orientation of the bearing surfaces 21 of the illustrated drive member 2.

In accordance with the illustrated embodiment, the transmission members are configured to urge the drive member to rotate. However, other embodiments are possible within the scope of the invention. It is for example possible to envisage configuring the transmission members to pull the drive member using a hook cooperating with suitable bearing surfaces of the drive member.

In accordance with the illustrated embodiment, the transmission members transmit to the drive member, to cause it to move, the power built up by a spring and previously accumulated during the winding of the corresponding transmission member, for example either using a timepiece movement or using a manual control mechanism. However, other sources of power are feasible for moving the transmission members. It is for example feasible for a transmission member to be directly driven in a reciprocating movement, for example by a timepiece movement through a suitable disconnecting system, by a manual lever, etc.

The elements of the kinematic chains between the transmission members and the corresponding sources of power can also differ from the racks and pinion implemented in the illustrated embodiment. These kinematic chains can for example comprise other types of gears and/or other forms of transmission elements, for example pulleys or any other suitable component.

The drive device has been described above with two transmission members acting on the same drive member and actuated by different means in accordance with different criteria. The drive device can of course comprise, within the scope of the invention, more than two transmission members configured to act on the same drive member so as to cause it to move. In accordance with some embodiments, for example, the drive device comprises, in addition to the first and second drive members described above, a third drive member configured to cause the drive member to move preferably in accordance with yet other criteria. The third drive member is for example actuated by a dedicated mechanism following an external prompt, for example an environmental prompt such as a variation in pressure, an acceleration, etc.

1. Drive device (1) for a timepiece mechanism, comprising:
a drive member (2) mounted so as to be rotationally movable around a rotary shaft (10) and configured to drive a timepiece mechanism, the drive member (2) comprising a plurality of bearing surfaces (21);
a first transmission member (3) movable in a winding movement from a first position of the first transmission member (3) to a second position of the first transmission member (3) and in a return movement from the second position of the first transmission member (3) to the first position of the first transmission member (3);
a second transmission member (4) movable in a winding movement from a first position of the second transmission member (4) to a second position of the second transmission member (4) and in a return movement from the second position of the second transmission member (4) to the first position of the second transmission member (4);
each transmission member (3; 4) being configured in order, during its return movement from its second position to its first position, to drive the drive member (2) to rotate by cooperating with a bearing surface (21) of the plurality of bearing surfaces (21);
the second transmission member (4) being configured not to block the rotation of the drive device (2) when the first transmission member (3) drives the drive member (2), and the first transmission member (3) being configured not to block the rotation of the drive member (2) when the second transmission member (4) drives the drive member (2).

2. Drive device (1) as claimed in claim 1, the first transmission member (3) and the second transmission member (4) being mounted so as to be rotationally movable about the rotary shaft (10) and rotating in one direction of rotation during the winding movement and in the opposite direction of rotation during the return movement.

3. Drive device (1) as claimed in claim 2, wherein the first transmission member (3) and the second transmission member (4) each comprise a pushing member (30, 40) for cooperating with the bearing surfaces (21) of the plurality of bearing surfaces (21) to urge the drive member (2) to rotate, each pushing member (30, 40) being located at the distal end of a flexible arm (30, 40), the proximal end of each of said flexible arms (30, 40) being rotatably mounted about the rotary shaft (10).

4. Drive device (1) as claimed in claim 1, further comprising a first spring (38) to move the first transmission member (3) in its return movement from its second position to its first position, and a second spring (48) to move the second transmission member (4) in its return movement from its second position to its first position.

5. Drive device (1) as claimed in claim 4, the first spring (38) and the second spring (48) being configured to be wound during the winding movement of the respective transmission member (3, 4).

6. Drive device (1) as claimed in claim 1, wherein the drive member (2) comprises teeth.

7. Drive device (1) as claimed in claim 1, wherein the bearing surfaces (21) of the plurality of bearing surfaces (21) are regularly distributed around the rotary shaft (10) on a diameter of the drive member (2).

8. Drive device (1) as claimed in claim 7, wherein the bearing surfaces (21) of the plurality of bearing surfaces are formed on an inner periphery of a ring (20) of the drive member (2), the ring (20) preferably being located protruding from a plate of the drive member.

9. Drive device (1) as claimed in claim 1, comprising a deactivation mechanism (5) allowing the first transmission member (3) to be decoupled from the drive member (2).

10. Timepiece comprising a timepiece movement and a drive device (1) as claimed in claim 1, wherein the first transmission member (3) is moved in its winding movement from its first position to its second position by the timepiece movement and the second transmission member (4) is configured to be moved in its winding movement from its first position to its second position by a manual control mechanism.

11. Timepiece as claimed in claim 10, wherein the deactivation mechanism (5) is actuated automatically when the timepiece movement is able to receive a time-setting operation.

12. Timepiece as claimed in claim 10, wherein the deactivation mechanism (5) can be actuated upon request by a user.
